(19) United States
(12) Patent Application Publication
(10) Pub. No.: US 2011/0074538 A1
(43) Pub. Date: Mar. 31, 2011

(54) ELECTRICAL FUSE STRUCTURE AND METHOD FOR FABRICATING THE SAME

(76) Inventors: Kuei-Sheng Wu, Tainan County (TW); Chang-Chien Wong, Tainan County (TW); Tzu-Chuan Huang, Tainan City (TW)

(21) Appl. No.: 12/566,681

(22) Filed: Sep. 25, 2009

(51) Int. Cl. H01H 85/02; H01H 69/02

(52) U.S. Cl. 337/187; 29/623; 337/158; 337/159

(57) ABSTRACT

An electrical fuse structure is disclosed. The electrical fuse structure includes: a fuse element disposed on surface of a semiconductor substrate; an anode electrically connected to one end of the fuse element; and a cathode electrically connected to another end of the fuse element, wherein no silicide is formed on at least part of the cathode of the electrical fuse structure.

### BACKGROUND OF THE INVENTION

1. Field of the Invention

The invention relates to an electrical fuse, and more particularly, to a fuse structure with no silicide formed on at least part of the cathode of the fuse structure.

2. Description of the Prior Art

As semiconductor processes become smaller and more complex, semiconductor components are influenced by impurities more easily. If a single metal link, a diode, or a MOS is broken down, the whole chip will be unusable. To treat this problem, fuses can be selectively blown for increasing the yield of IC manufacturing.

In general, fused circuits are redundant circuits of an IC. When defects are found in the circuit, fuses can be selectively blown for repairing or replacing defective circuits. In addition, fuses provide the function of programming circuits for various customized functions. Fuses are classified into two categories based on their operation: thermal fuse and electrical fuse. Thermal fuses can be cut by lasers and be linked by laser repair. An electrical fuse utilizes electro-migration for both forming open circuits and for repairing. The electrical fuse for semiconductor devices may be classified into categories of poly electrical fuse, MOS capacitor anti-fuse, diffusion fuse, contact electrical fuse, contact anti-fuse, and the like.

A blowing mechanism of conventional electrical fuse is shown in FIG. 1. The cathode of an electrical fuse structure 1 is electrically connected to the drain of the transistor as a blowing device 2 (or referred to be as a driver). Voltages Vfs and Vg are applied on the anode of the electrical fuse structure 1 and the gate of the transistor respectively. The source of the transistor is grounded. The electric current is traveled from the anode of the electrical fuse structure 1 to the cathode of the electrical fuse structure 1; and the electrons flow from the cathode of the electrical fuse structure 1 to the anode of the electrical fuse structure 1. The electric current suitable for the blowing is in a proper range. If the electric current is too low, the electron-migration is not completed, whereas if the current is too high, the electrical fuse tends to be thermally ruptured.

Typically, fuse element, anode and cathode of a conventional electrical fuse is composed of polysilicon material, and silicide layer and plurality of contact plugs are disposed on top of the fuse element, the anode and the cathode. Silicide layers are formed to enhance the electrical connection between each contact plug and the electrodes. The contact plug disposed on the cathode is preferably used to provide enough electronic current to the cathode and facilitate the flow of electrons to polysilicon and silicide layer of the fuse element through electron migration, thereby blowing off the fuse structure. In a typical 45 nm fabrication process, the blowing current for an electrical fuse structure is between 9 mA to 14.5 MA. In order to reach this degree of current, a blowing device (such as a MOS transistor) with larger size is usually needed. This not only complicates the fabrication process, but also creates difficulty for lower scale integration. Hence, how to improve the current electrical fuse structure to reach electron migration under small current has become an important task.

### SUMMARY OF THE INVENTION

It is an objective of the present invention to provide an electrical fuse structure for improving the aforementioned bottleneck of current fuse structure.

According to a preferred embodiment of the present invention, an electrical fuse structure is disclosed. The electrical fuse structure includes: a fuse element disposed on surface of a semiconductor substrate; an anode electrically connected to one end of the fuse element; and a cathode electrically connected to another end of the fuse element, wherein no silicide is formed on at least part of the cathode of the electrical fuse structure.

It is another aspect of the present invention to provide a method for fabricating an electrical fuse structure. The method includes the steps of: providing a semiconductor substrate having a transistor region and a fuse region; forming a transistor on the transistor region of the semiconductor substrate; forming a fuse element, a cathode, and an anode on the fuse region of the semiconductor substrate; forming a salicide block on at least a portion of the cathode; and forming a silicide layer on the transistor region and a portion of the fuse region.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a blowing mechanism of a conventional fuse structure.

FIG. 2 illustrates a top-view of an electrical fuse structure according to a preferred embodiment of the present invention.

FIG. 3 illustrates a cross-sectional view of FIG. 2 along sectional line BB'.

FIGS. 4-6 illustrate top views of forming the salicide block on an electrical fuse structure according to other embodiments of the present invention.

FIG. 7 illustrates a top view of an electrical fuse structure according to an embodiment of the present invention.

FIGS. 8-9 illustrate an integrated fabrication of a MOS transistor and an electrical fuse structure according to an embodiment of the present invention.

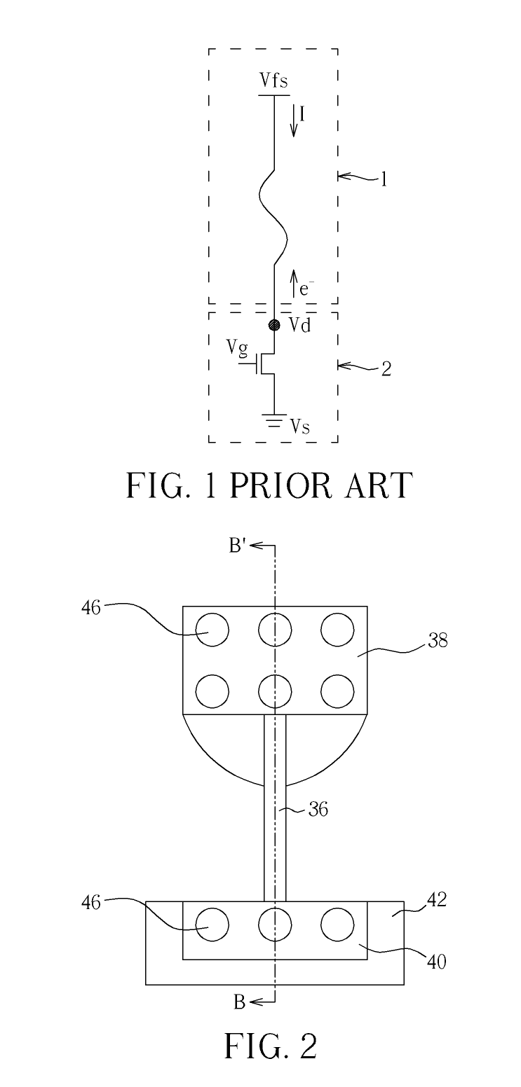

### DETAILED DESCRIPTION

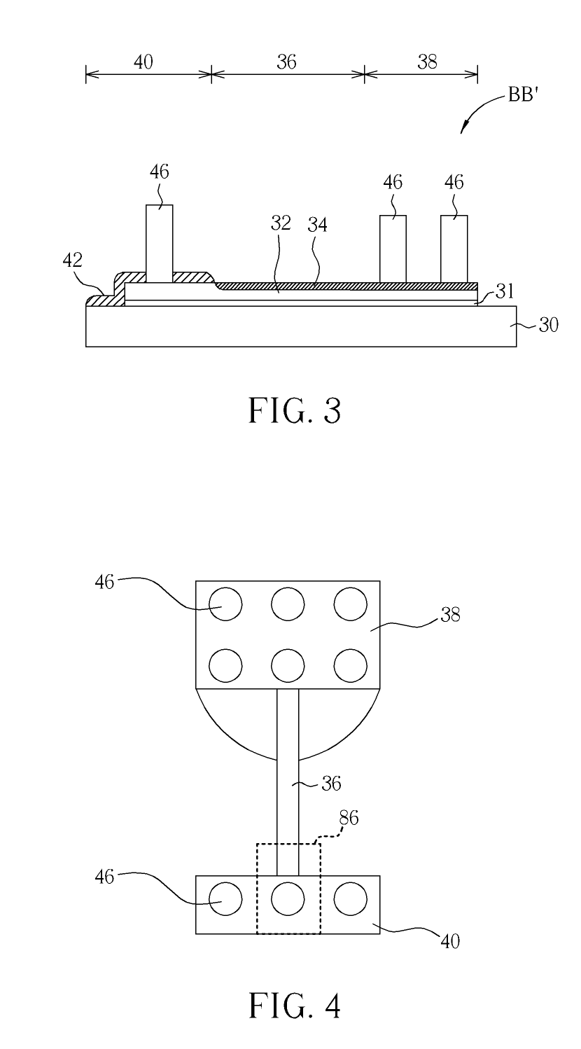

Referring to FIGS. 2-3, FIG. 2 illustrates a top-view of an electrical fuse structure according to a preferred embodiment of the present invention, and FIG. 3 illustrates a cross-sectional view of FIG. 2 along sectional line BB'. As shown in the figures, a semiconductor substrate 30 is provided, and an insulating layer 31 such as a silicon substrate composed of SiCOH, SiO₂ or Si₃N₄ is formed on the semiconductor substrate 30. A polysilicon layer (not shown) is then deposited on the semiconductor substrate 30, and a pattern transfer is conducted by using patterned photoresist to remove a portion of the polysilicon layer to form a fuse element 36 and an anode 38 and a cathode 40 connected to two ends of the fuse element 36 on the insulating layer 31, in which the fuse element 36, the anode 38, and the cathode 40 are composed of a patterned polysilicon layer 32. In this embodiment, the fuse element 36, the anode 38, and the cathode 40 are preferably composed of polysilicon material fabricating from the pattern transfer of the fuse element 36. Alternatively, the fuse element 36, the anode 38, and the cathode 40 could also be composed of any conductive material, such as polysilicon, metal, or combination thereof, and materials used for forming the fuse element 36, the anode 38, and the cathode 40 could be of same material or different material.

A silicide process is then performed by first covering a salicide block (SAB) 42 composed of SiO₂ or TEOS on at least a portion of the cathode 40, and a metal layer (not shown) composed of cobalt, titanium, nickel, platinum, palladium, or molybdenum is disposed on region not covered by the salicide block 42, such as at least a portion of the fuse element 36, the anode 38, and a portion of the cathode 40 not covered by the salicide block 42. Next, a rapid thermal annealing process is conducted to react the metal layer and surface of the polysilicon layer 32 to form a silicide layer 42, and un-reacted metal layer is removed thereafter.

Next, a dielectric layer (not shown) is formed on the fuse element 36, the cathode 40, and the anode 38 and a photo-etching process is performed to remove a portion of the dielectric layer for forming a plurality of contact openings exposing part of the anode 38 and part of the cathode 40. A metal selected from a group consisting of W, Al, Cu, Ta, TaN, Ti, and TiN is then deposited into the conductive openings to form a plurality of conductive plugs 46 electrically connected to the anode 38 and the cathode 40. This completes an electrical fuse structure according to a preferred embodiment of the present invention.

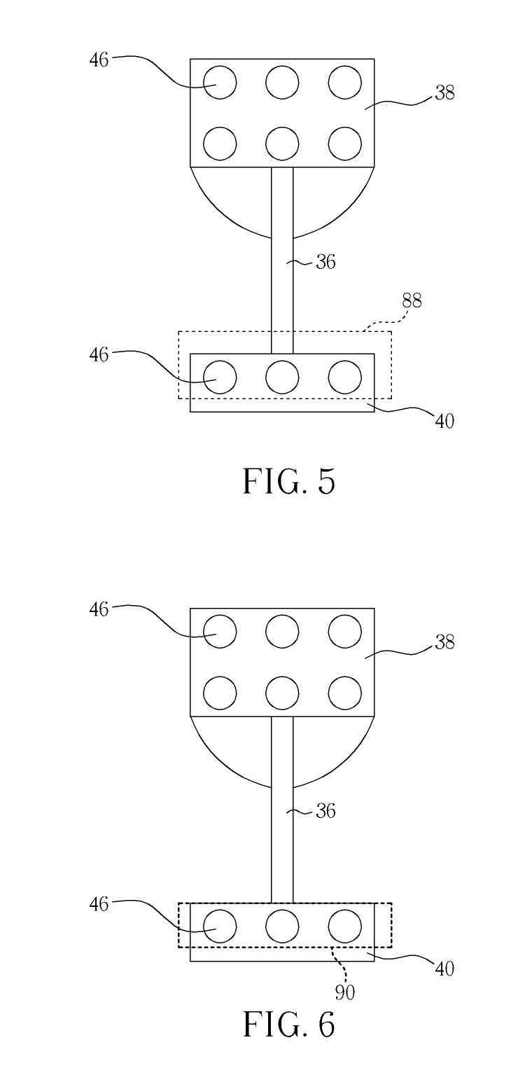

It should be noted that in addition to covering the salicide block 42 on at least a portion of the cathode 40, the area and position of the salicide block 42 could also be adjusted according to the demand of the product, thereby controlling the position of the silicide layer 24 thereafter. Referring to FIGS. 4-6, FIGS. 4-6 illustrate top views of forming the salicide block 42 on an electrical fuse structure according to other embodiments of the present invention. For instance, the salicide block 42 could be disposed on region 86 (as shown in FIG. 4), region 88 (as shown in FIG. 5), or region 90 (as shown in FIG. 6). Region 86 represents that the salicide block 42 is only disposed on the central plug 46 of the cathode 40 and a portion of the fuse element 36, hence the silicide layer 34 is preferably formed on the two other end plugs 46 not covered by the salicide block 42 and a portion of the cathode 40 and fuse element 36 not covered by region 86. Region 88 represents that the salicide block 42 is disposed on all contact plugs 46 of the cathode 40 and a portion of the fuse elements 36, hence the silicide layer 34 is formed on part of the fuse element 36 and entire anode 38 not covered by the region 88. Region 90 represents that the salicide block 42 is only disposed on the contact plugs 46 of the cathode 40 but not any of the fuse element 36 and the anode 38, hence the silicide layer 34 is formed on the entire fuse element 36 and the anode 38.

As the contact plugs on the anode 38 are contacting the silicide layer 34 directly while at least one of the contact plugs 46 on the cathode 40 are penetrating the salicide block 42 to contact the polysilicon layer 32 directly, the resistance of the fuse structure would be greater at the cathode 40 end, which would further create more heat and temperature and facilitate electron migration from the tungsten metal of the contact plugs 46 at the cathode 40 end and result in a blow up of the fuse structure. According to a preferred embodiment of the present invention, a complete blow up and electron migration of the proposed electrical fuse structure only requires less than 9 mA of electrical current. Moreover, as no silicide layer 34 is formed on the portion of the cathode 40 adjacent to the fuse element 36, no silicides are compensated to the fuse element 36 end from the cathode 40 during the blow up of the fuse structure and the blow up time is reduced substantially.

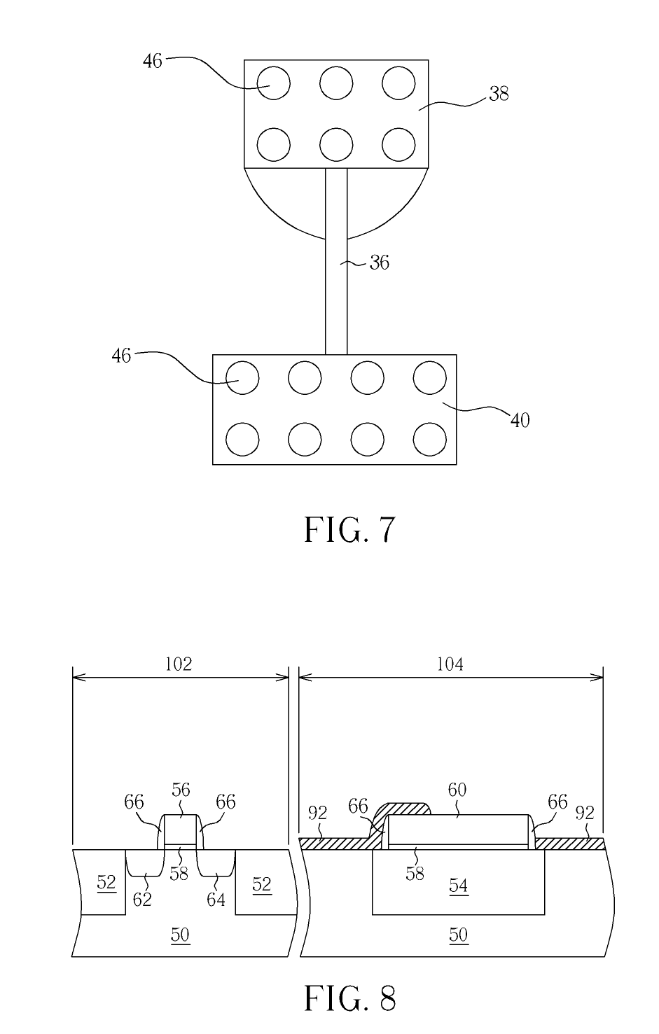

In addition to the aforementioned embodiment of only disposing three contact plugs 46 on a single row, the quantity and arrangement of the contact plugs 46 could also be adjusted according to the demand of the product. For instance, a total of eight contact plugs arranged in two rows could also be formed at the cathode 40 end, as shown in FIG. 7, and the various embodiments of disposing the salicide block 42 as discussed above could be applied in this design, which is also within the scope of the present invention.

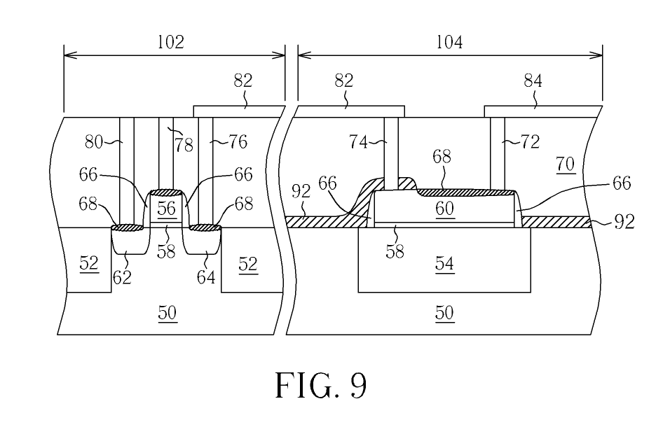

The aforementioned embodiment only forms an electrical fuse structure on a semiconductor substrate 30. Alternatively, the fabrication of the electrical fuse structure could also be integrated with fabrication of a MOS transistor, which is also within the scope of the present invention. Referring to FIGS. 8-9, FIGS. 8-9 illustrate an integrated fabrication of a MOS transistor and an electrical fuse structure according to an embodiment of the present invention. As shown in FIG. 8, a semiconductor substrate 50 is first provided. A transistor region 102 and a fuse region 104 are defined on the semiconductor substrate 50. An isolation process is conducted to form a shallow trench isolation 52 in the semiconductor substrate 50 between the transistor region 102 and the fuse region 104 and another shallow trench isolation 54 in the fuse region 104. A dielectric layer (not shown) composed of oxide is deposited over the surface of the semiconductor substrate 50, and a gate electrode layer (not shown) preferably composed of polysilicon is formed on the dielectric layer thereafter. A photo-etching process is conducted to remove a portion of the gate electrode layer and the dielectric layer to form a gate electrode 56 and a gate dielectric layer 58 on the semiconductor substrate 50 of the transistor region 102 and a fuse pattern 60 composed of fuse element, cathode region, and anode region on the shallow trench isolation 54 of the fuse region 104. Despite the gate electrode layer in this embodiment is composed of polysilicon, the gate electrode layer could also be composed of metal or stacked structure of metal and polysilicon, which are all within the scope of the present invention.

A spacer 66 is formed on the sidewall of the gate electrode 56 and the fuse pattern 60, and an ion implantation process is conducted to form a source/drain region 62/64 in the semiconductor substrate 50 adjacent to two sides of the spacer 66 within the transistor region 102. The present embodiment preferably forms one single spacer 66 and one source/drain region 62/64. Alternatively, a plurality of spacers could be formed on the sidewall of the gate electrode 56 while accompanying a lightly doped drain fabrication. For instance, an offset spacer could first formed on the sidewall of the gate electrode, and a light ion implantation is performed to form a lightly doped drain adjacent to two sides of the offset spacer. A main spacer is formed around the offset spacer thereafter, and a heavy ion implantation is conducted to form a source/drain region adjacent to two sides of the main spacer. The order for forming the aforementioned offset spacer, main spacer, lightly doped drain, and source/drain region could also be adjusted according to the demand of the product, which are all within the scope of the present invention.

A silicide process is then performed by first covering a salicide block (SAB) 92 composed of SiO₂ or TEOS on the transistor region 102 not intended to form silicide, such as regions outside the gate electrode 56 and the source/drain region 62/64, and at least a portion of the cathode of the fuse pattern 60 in the fuse region 104. Next, a metal layer (not shown) composed of cobalt, titanium, nickel, platinum, palladium, or molybdenum is disposed on region not covered by the salicide block 92, and a rapid thermal annealing process is conducted to form a silicide layer 68 on the gate electrode 56 and source/drain region 62/64 of the transistor region 102 and the fuse element, anode, and part of cathode not covered by the salicide block of the fuse region 104, as shown in FIG. 9. After removing un-reacted metal layer, a MOS transistor is formed in the transistor region 102 and an electrical fuse is formed in the fuse region 104.

As discussed in the aforementioned embodiment, the silicide layer 68 is preferably disposed on at least part of the fuse element and anode. Nevertheless, the silicide layer 68 could also be disposed on part of the cathode depending on the demand of the product.

Next, a dielectric layer 70 composed of oxides or nitrides is formed on the transistor region 102 and the fuse region 104, and a photo-etching process is conducted to remove a portion of the dielectric layer 70 to form a plurality of contact openings while exposing a portion of the silicide layer 68 disposed on top of the gate electrode 56 and the source/drain region 62/64 of the transistor, and the polysilicon material of the cathode end and silicide layer 68 of the anode end of the fuse pattern 60.

A metal selected from a group consisting of W, Al, Cu, Ta, TaN, Ti, and TiN is then deposited in the contact openings to form a plurality of conductive plugs 72/74/76/78/80 electrically connected to the MOS transistor and the fuse pattern 60. Preferably, the contact plugs 72/76/78/80 are formed to directly contact the silicide layer 68, whereas the contact plug 74 is formed to penetrate through the salicide block 92 and contacting the polysilicon of the cathode directly. Next, a metal interconnective process is performed to form metal interconnects 82 connecting conductive plug 74 of the cathode and plug 76 of the MOS transistor, and a metal interconnect 84 connecting plug 72 of the anode and peripheral logic circuits. This completes the integrated fabrication of a MOS transistor and an electrical fuse structure.

Those skilled in the art will readily observe that numerous modifications and alterations of the device and method may be made while retaining the teachings of the invention.

What is claimed is:

1. An electrical fuse structure, comprising:
a fuse element disposed on surface of a semiconductor substrate;
an anode electrically connected to one end of the fuse element; and
a cathode electrically connected to another end of the fuse element, wherein no silicide is formed on at least part of the cathode of the electrical fuse structure.

2. The electrical fuse structure of claim 1, wherein no silicide is formed on entire surface of the cathode.

3. The electrical fuse structure of claim 1, wherein no silicide is formed on at least part of the fuse element.

4. The electrical fuse structure of claim 1, wherein a silicide layer is formed on the anode.

5. The electrical fuse structure of claim 1, wherein the width of the fuse element is less than the width of the anode and width of the cathode.

6. The electrical fuse structure of claim 1, further comprising a plurality of contact plugs electrically connected to the cathode and the anode.

7. A method for fabricating an electrical fuse structure, comprising:
providing a semiconductor substrate having a transistor region and a fuse region;
forming a transistor on the transistor region of the semiconductor substrate;
forming a fuse element, a cathode, and an anode on the fuse region of the semiconductor substrate;
forming a salicide block on at least a portion of the cathode; and
forming a silicide layer on the transistor region and a portion of the fuse region.

8. The method of claim 7, further comprising forming the salicide block to fully cover the surface of the cathode.

9. The method of claim 7, further comprising forming the salicide block to partially cover the fuse element.

10. The method of claim 7, further comprising forming the silicide layer on source/drain region of the transistor in the transistor region.

11. The method of claim 7, further comprising forming the silicide layer on the anode of the fuse region.

12. The method of claim 7, further comprising forming the silicide layer on a portion of the fuse element of the fuse region.

13. The method of claim 7, further comprising forming the silicide layer on a portion of the cathode of the fuse region.

14. The method of claim 7, further comprising forming a plurality of contact plugs electrically connected to the silicide layer of the transistor region and the fuse region.
